(19) United States
(12) Patent Application Publication
(10) Pub. No.: US 2015/0214820 A1
(43) Pub. Date: Jul. 30, 2015

(54) HAIRPIN JOINT

(71) Applicant: Remy Technologies, LLC, Pendleton, IN (US)

(72) Inventors: Greg Geoffrion, Pendleton, IN (US); Ronald Gentry, Cicero, IN (US); Kristopher Graves, Fishers, IN (US); James Paul Murphy, Fishers, IN (US)

(21) Appl. No.: 14/163,252

(22) Filed: Jan. 24, 2014

(51) Int. Cl. H02K 15/00; B23K 1/00; B23K 11/00

(52) U.S. Cl. CPC H02K 15/0068; B23K 11/002; B23K 1/0004

(57) ABSTRACT

A method of forming a stator winding includes providing a stator core having a plurality of longitudinally extending slots formed about a circumference thereof, providing a plurality of hairpin conductors each having a substantially rectangular cross-section and each having an apex portion and a pair of legs that terminate at respective ends, cutting a bevel at each leg end, inserting the hairpin legs into respective ones of the slots so that the leg ends extend from an axial end of the stator core, bending the hairpin legs to form a plurality of adjacent pairs of leg ends with beveled cuts facing one another, compressing the beveled cuts of each pair together, and resistance welding the pairs to form a plurality of welded joints.

### BACKGROUND

The present invention is directed to improved reliability and manufacturability of an electric machine and, more particularly, to welded interconnections of a stator winding.

Dynamoelectric machines in automotive applications include alternators, alternator-starters, traction motors, and others. The stator of an electric machine typically includes a cylindrical core formed as a stack of individual laminations and having a number of circumferentially spaced slots that extend longitudinally through the stator core. A rotor assembly includes a center shaft and is coaxial with the stator core. The stator core has wires wound thereon in the form of windings that extend axially through ones of the core slots. End turns are formed in the windings at the two axial ends of the stator core, whereby a given winding forms an end loop as it extends circumferentially to a different slot.

Stator windings may be formed by inserting and then connecting together individual “hairpin” conductors each having a crown or apex portion and having two legs that extend in a same general direction. For example, hairpins may be formed from a heavy gauge copper wire with a rectangular cross section, into a predetermined shape for insertion into specific rectangular slots in the stator core. Hairpin conductors are typically coated with an insulating material prior to insertion, so that adjacent hairpin surfaces within a slot are electrically insulated from one another.

Typically, the apex portions of the hairpins protrude from one axial end of the stator core and the leg ends of the hairpins protrude from the opposite axial end. After insertion, the portions of the legs protruding from the stator core are bent to form a complex weave from wire to wire, creating a plurality of adjacent wire end pairs. Adjacent paired wire ends are typically joined to form individual electrical connections, such as by a welding operation. In a given electric machine, it may be desirable to join together the cross-sectionally short sides of rectangular hairpins. Such short hairpin sides may also include rounded corners, so that the engagement surfaces of the adjacent pair that form the faying surfaces of a weld are difficult to align. As a result, the joinder of adjacent pairs of hairpins may result in a number of connections having increased resistance and/or defective joints. For example, the faying surfaces may slide laterally and become misaligned, and/or the contact surface area at a welded joint may be insufficient for reducing electrical resistance and improving electrical performance.

### SUMMARY

It is therefore desirable to obviate the above-mentioned disadvantages by providing a method and structure for joining hairpin type conductors.

According to an exemplary embodiment, a method of forming a stator winding includes providing a stator core having a plurality of longitudinally extending slots formed about a circumference thereof, providing a plurality of hairpin conductors each having a substantially rectangular cross-section and each having an apex portion and a pair of legs that terminate at respective ends, cutting a bevel at each leg end, inserting the hairpin legs into respective ones of the slots so that the leg ends extend from an axial end of the stator core, bending the hairpin legs to form a plurality of adjacent pairs of leg ends with beveled cuts facing one another, compressing the beveled cuts of each pair together, and resistance welding the pairs to form a plurality of welded joints.

The foregoing summary does not limit the invention, which is defined by the attached claims. Similarly, neither the Title nor the Abstract is to be taken as limiting in any way the scope of the claimed invention.

### BRIEF DESCRIPTION OF THE DRAWING FIGURES

The above-mentioned aspects of exemplary embodiments will become more apparent and will be better understood by reference to the following description of the embodiments taken in conjunction with the accompanying drawings, wherein:

FIG. 1 is a partial perspective view of a connection end of an exemplary stator core populated with hairpin type conductors;

FIG. 2 is a perspective view of a hairpin conductor, according to an exemplary embodiment;

FIG. 3 is a partial perspective view of a section of conductor wire being formed in an exemplary hairpin manufacturing operation;

FIG. 4 is a top plan view and FIG. 5 is a partial perspective view of two exemplary hairpin conductor ends in position for being connected to one another;

FIG. 6 is a partial perspective view of hairpin conductor ends joined together by an exemplary process described herein;

FIG. 7 is a partial perspective view of the connection end of a fully populated stator having welded pairs of conductor ends, according to an exemplary embodiment;

FIG. 8 is a schematic view of conductor ends during a process of being joined together, according to an exemplary embodiment;

FIG. 9 is a schematic view of conductor ends during a process of being joined together, according to an exemplary embodiment; and

FIG. 10 is a top plan view of two exemplary hairpin conductor ends in position for being connected to one another, according to an exemplary embodiment.

Corresponding reference characters indicate corresponding or similar parts throughout the several views.

### DETAILED DESCRIPTION

The embodiments described below are not intended to be exhaustive or to limit the invention to the precise forms disclosed. Rather, the embodiments are chosen and described so that others skilled in the art may appreciate and understand the principles and practices of these teachings.

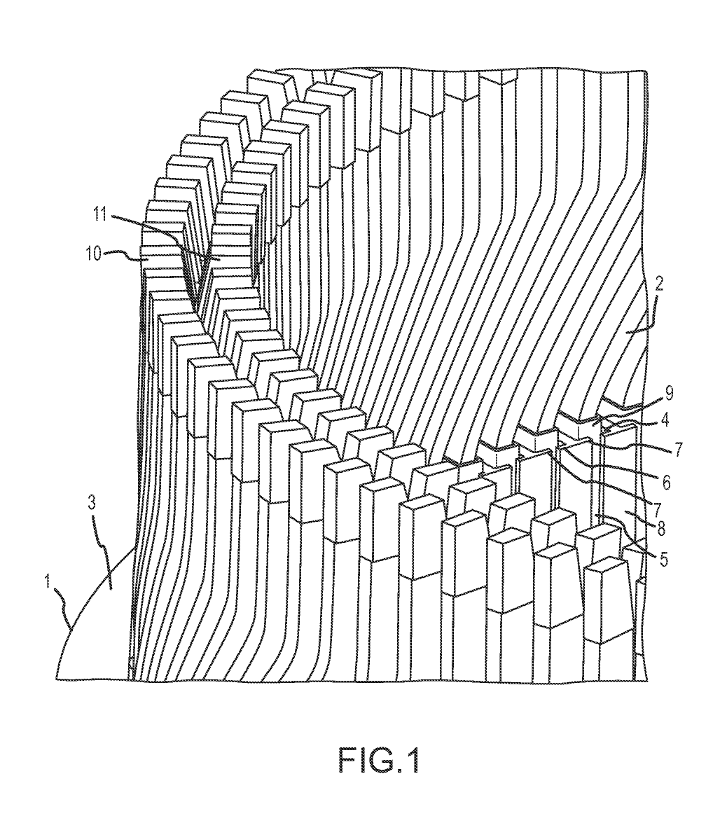

FIG. 1 is a partial perspective view of an axial end 3 (connection end) of an exemplary stator core 1 populated with hairpin type conductors 2. Core 1 has a plurality of longitudinally extending slots 4 spaced around a circumference thereof. The radially inner ends of slots 4 are partially closed so that only a narrow longitudinally extending slit 5 separates adjacent slots 4. This partial closure of the radially inner portion of each slot 4 is defined by opposed shoulder portions 6, 7 of adjacent teeth 8. Each leg portion of a respective hairpin conductor 2 contained within a slot 4 is surrounded by an electrically insulating slot liner 9 or similar sleeve that keeps the conductor portion from electrically connecting or shorting to other conductor portions or to stator core 1. The conductor ends 10 of a radially outer layer may be connected to conductor ends 11 of an inwardly adjacent radial layer of conductors extending circumferentially around stator core 1. Such connections may be implemented by welding, brazing, jumpers, and/or by other structure.

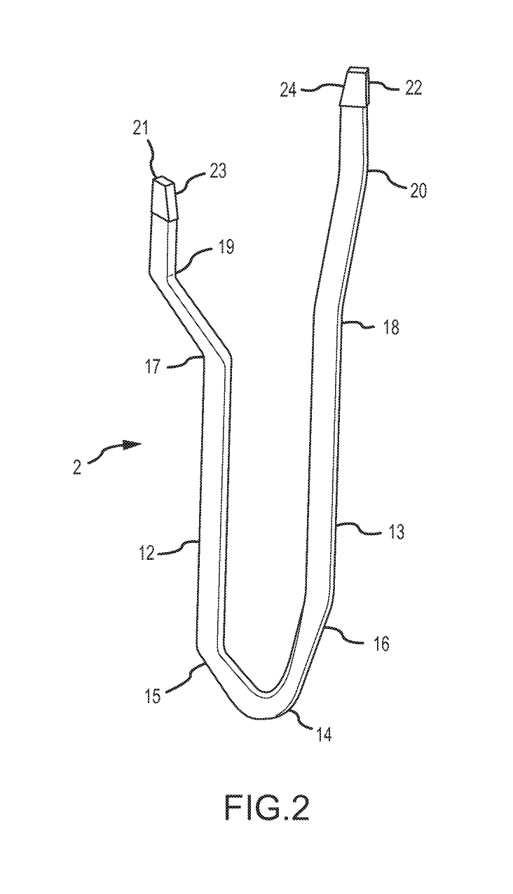

FIG. 2 is a perspective view of a hairpin conductor 2, according to an exemplary embodiment. Hairpin conductor 2 may be formed of substantially rectangular copper wire, such as wire having rounded corners and nominal dimensions of about one sixteenth inch by one eighth inch. Typically, the end turn portions of all hairpins are disposed at one axial end of stator core 1 and the connection ends of all hairpins are disposed at the opposite axial end. Prior to insertion into slots 4 of a stator core 1, the leg portions 12, 13 are unbent and extend away from the end turn portions, each defined with an apex 14 and turning portions 15, 16. After being inserted into respective slots 4, legs 12, 13 are first bent at respective bends 17, 18 and then at respective second bends 19, 20. The two distal ends 21, 22 each have respective tapered surfaces 23, 24 that are cut along one side thereof.

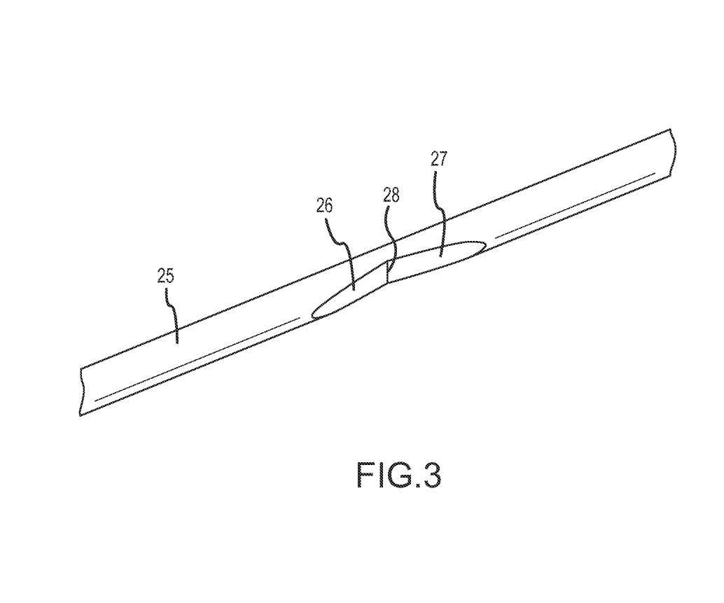

FIG. 3 is a partial perspective view of a section of conductor wire 25 being formed in an exemplary hairpin manufacturing operation. A notch is stamped to provide a first taper face 26 and a second taper face 27 that meet at an intersection 28. After the notch is stamped, the wire section is cut along intersection 28 to thereby provide taper faces 26, 27 for respective subsequent use as tapered surface 23 or 24 of hairpin 2.

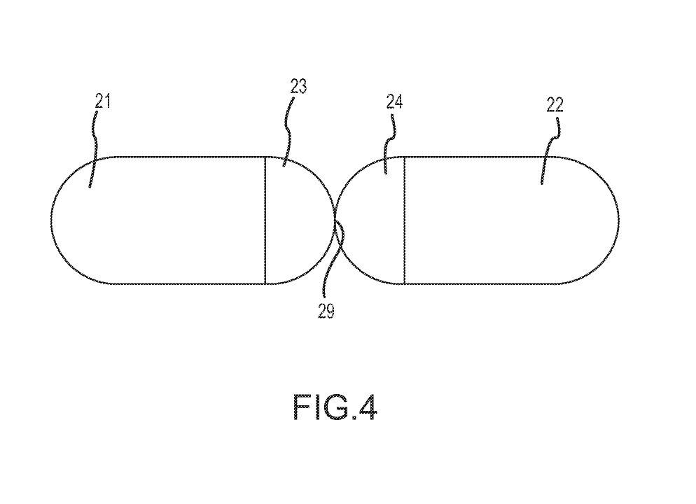

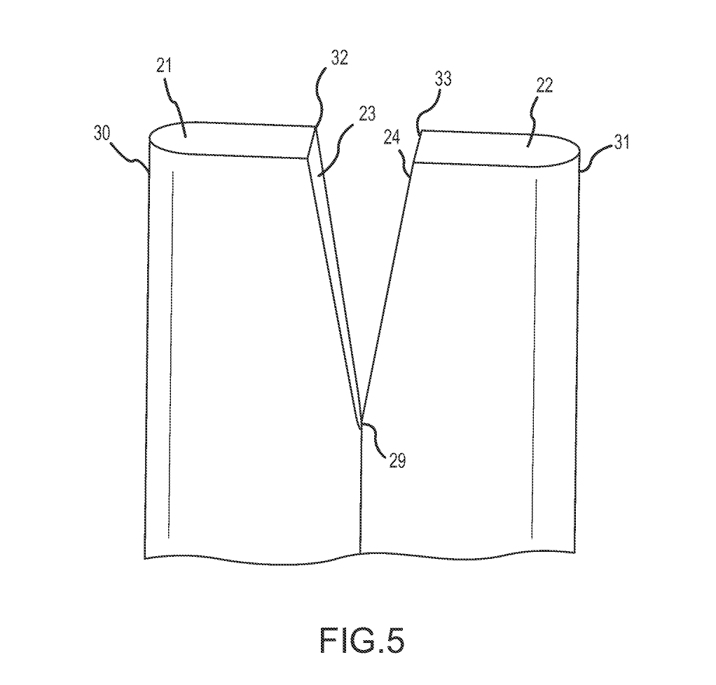

FIG. 4 is a top plan view and FIG. 5 is a partial perspective view of two exemplary hairpin conductor ends in position for being connected to one another. Conductor ends 21, 22 are placed into abutment or into close proximity at a location 29.

Two resistance welding electrodes, discussed further below, respectively contact conductor ends 21, 22 at engagement locations 30, 31. The electrodes may be angled so that when they are moved toward one another during a welding operation, they push tapered surfaces 23, 24 toward one another. For example, when the gap between tapered surfaces 23, 24 is approximately one-quarter inch to one-half inch, and when the electrodes press toward one another with a force of approximately fifty to six hundred pounds of force, conductor ends 21, 22 are bent so that upper edges 32, 33 are made contiguous. When edges 32, 33 touch one another, welding current flows through such contiguous portions. As the welding current is gradually increased, the copper of conductor ends 21, 22 is annealed and softens. In order to prevent lateral movement of conductor ends 21, 22 during the welding, the electrodes may be provided with forked or notched surfaces that keep conductor ends 21, 22 in alignment with one another. Peak welding current may be 5,000 to 10,000 amperes, or any other suitable current. Typically, engagement locations 30, 31 are as close as practical to respective conductor ends 21, 22. As the welding current and compressive force of the electrodes are maintained, the remaining portions of tapered surfaces 23, 24 are made flush and mated. The gradual increase in welding current allows the copper conductor material to soften and be easily compressed. A brazing alloy may be provided. For example, a brazing alloy may be a SIL-FOS composition primarily containing copper, silver, and phosphorous (SIL-FOS is a registered trademark of Handy & Harmon Corp., White Plains, N.Y.). The brazing alloy may be placed to direct welding current there-through. In particular, the electrical resistance of the brazing alloy may be about five or ten times that of the hairpin conductor, whereby the alloy becomes much hotter than the hairpin during the initial welding period and creates a brazed joint, and where continued welding current directs the joinder of hairpin legs along the intersection of tapered surfaces 23, 24. For example, brazing alloy may be formed or placed along outer edge surfaces 32, 33 so that the joinder of surfaces 23, 24 begins at an intersection of edges 32, 33 and proceeds along such joined surfaces toward location 29. When surfaces 23, 24 are properly joined to be flush, the welding current is removed while the electrodes remain in place until the weld cools and is mechanically stable. It may be necessary to pull the brazing alloy tape to disengage it from the weld after a portion of the brazing tape has melted. The brazing alloy may be provided as a tape having lateral perforations that allow the tape to be easily broken away from the portion of the brazing tape being applied. In such a case, a measured, consistent amount of brazing alloy may be applied.

Welding parameters such as time, incremental (e.g., 0.5 milliseconds) current levels, rise and decay times, pulse width, duty cycle, cooling time, and others may be accurately controlled with a mid-frequency resistance welding machine. For example, the various welding parameters may be controlled according to profiles based on any number of criteria. The non-destructive softening effected by controlled application of welding current allows the copper of conductor ends 21, 22 to soften and be more easily bent and compressed. Generally, longer weld periods having a more gradual rise in current and associated heat may allow use of a lesser compressive force. For example, when welding current rise time is increased, a small compressive force of approximately thirty to eighty pounds may be sufficient and this lower compressive force may reduce the possibility of misalignment respecting conductor ends 21, 22. Similarly, the compressive force may be modulated to optimize the level of applied heat. For example, the electrical resistance at a welding target location may be increased by using a relatively smaller amount of compressive force. This increased electrical resistance provides increased localized heat during the application of welding current. The brazing alloy also facilitates rapid heat transfer, so that the softening of copper and the compression of softened copper into a joint may be performed without excessive melting and without effecting a destructive welding process. In particular, the conductivity of brazing alloy is low, for example eighteen percent, and such low conductivity acts as an electrical resistance that generates heat during the resistance brazing/welding.

In an exemplary embodiment, a large initial compressive force acts to bend the copper so that edges 32, 33 come into contact; compressive force may then be reduced to assure that sufficient heat is then maintained for melting the brazing alloy and softening the copper, and where the compressive force may again be modified to assure that the weld is accurately formed. Typically, a fillet (not shown) is formed in a weld region having the highest peak temperature. In another example, a small compressive force can quickly provide sufficient heat to begin softening the copper in joint portions that are already in contact. A relatively large initial compression may bend conductor ends 21, 22 until the distal ends of edges 32, 33 come into contact; after coming into contact, a greatly reduced compressive force allows the electrical resistance between faying surfaces to remain high, whereby welding heat is maintained. By comparison, if the compressive force exerted by the electrodes is too great, the electrical resistance at the joint becomes too small for maintaining proper welding heat. In another example, a medium-sized initial compressive force, such as about two hundred pounds, and a small welding current, such as about 1,000 amperes for thirty to ninety milliseconds, may be utilized for engaging edges 32, 33 and then softening the copper conductor ends 21, 22; the compressive force may then be increased to about 300 pounds and the welding current may be increased to about 5,000 amperes until faying surfaces 23, 24 are fully flush and mated. The brazing alloy melts during this 5,000 ampere period. The associated temperature rise is nonlinear, as the increased heat causes the electrical resistance of the copper to increase. The welding current is turned off while the electrodes remain in their final position until the weld cools. Typically, the welding electrodes have a fluid cooling system in close proximity to the work surface, so that the cooling of the electrodes and weld requires only a small amount of time, such as one-quarter second to one second or more.

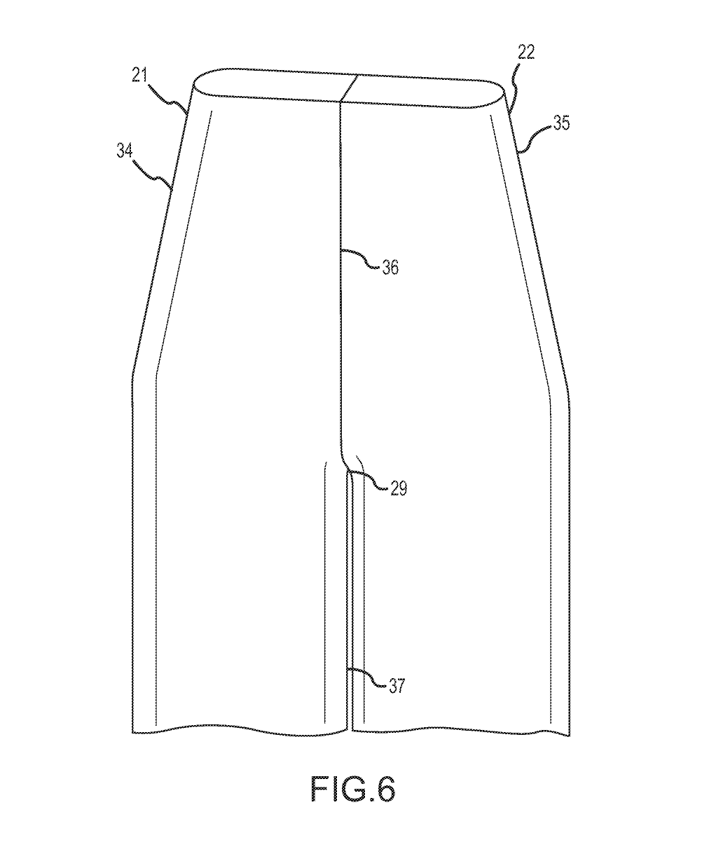

FIG. 6 is a partial perspective view of hairpin conductor ends 21, 22 joined together by the exemplary process described above. The radially outer side of conductor end 21 and the radially outer side 35 of conductor end 22 are angled toward each other by the compressing and welding. The corresponding radially inner edges of conductor ends 21, 22 are joined along a seam/joint 36 that extends axially outward from axially inner location 29. An axially inner space 37 may be formed between conductors.

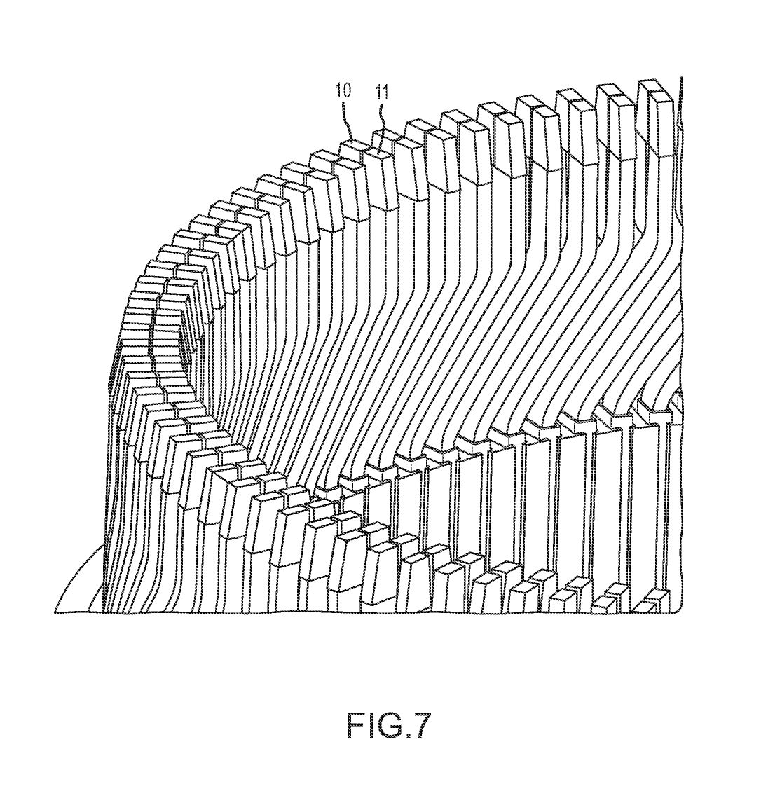

FIG. 7 is a partial perspective view of the connection end of a fully populated stator having welded pairs of conductor ends 10, 11, according to an exemplary embodiment. Radially outer conductor ends 10 are each joined to a respective one of radially inner conductor ends 11. The joinder may include brazing and/or welding.

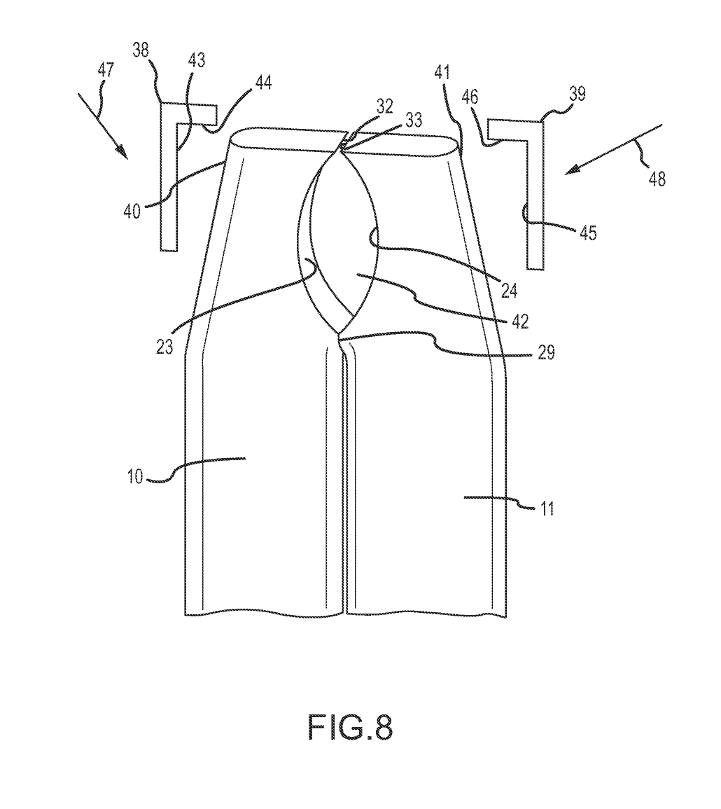

FIG. 8 is a schematic view of conductor ends 10, 11 during a process of being joined together, according to an exemplary embodiment. A radially outer electrode head 38 and a radially inner electrode head 39 are shown at a distance away from respective conductor contact areas 40, 41 for clarity of description. The illustrated view shows edges 32, 33 already bent, to a position where they are in close proximity, by the compressive force of electrode heads 38, 39. A gap 42 is thereby created between faying surfaces 23, 24, where gap 42 extends axially from location 29 to the distal end at the intersection of edges 32, 33. Electrode head 38 is formed with a “V” shape having contact surfaces 43, 44. Electrode head 39 is formed with a “V” shape having contact surfaces 45, 46. A compressive force 47 urges surfaces 43, 44 of electrode head 38 against conductor contact area 40. A compressive force 48 urges surfaces 45, 46 of electrode head 39 against conductor contact area 41.

Compressive forces 47, 48 may each be applied at an angle in order to optimize and direct the compression of surfaces 23, 24 toward one another. Such angle may be changed during a welding operation. For example, the angle may initially be chosen to press edges 32, 33 into contact in order to direct the welding current therethrough. Once edges 32, 33 are in contact and have an electrical resistance between them, localized heating begins and the angle(s) may be changed for more efficiently and precisely pressing surfaces 23, 24 together. In another exemplary embodiment, electrode heads 38, 39 may be stepped into position and then used to apply respective compressive forces 47, 48 in a first compression, and may then be stepped into another position for applying compressive forces 47, 48 in a second compression, etc. Various shapes may alternatively be implemented in forming electrode heads 38, 39, although the respective sizes of electrode heads 38, 39 may not exceed available circumferential working space for each conductor pair being joined. For example, respective contacting surfaces of electrode heads 38, 39 may each be formed as single plane surfaces each having a groove formed therein for capturing the associated conductor wire targets 40, 41. The shapes of electrode heads 38, 39 may be chosen for holding/retaining and/or aligning conductor ends 10, 11.

Even when the planes defined as tapered surfaces 23, 24 are properly aligned for being joined together, lateral movement may be possible, and such lateral movement may be reduced or prevented by forming mating feature(s) in conductor ends 21, 22, discussed further below, and/or by utilizing electrodes having shapes that retain engagement locations 30, 31 and prevent lateral misalignment. In an exemplary embodiment, the welding electrodes may have a contact area of approximately one-quarter inch by one-quarter inch, for welding together each of 108 adjacent pairs of conductor ends 21, 22 in a fully populated six inch diameter stator where adjacent welds are approximately one-eighth inch apart.

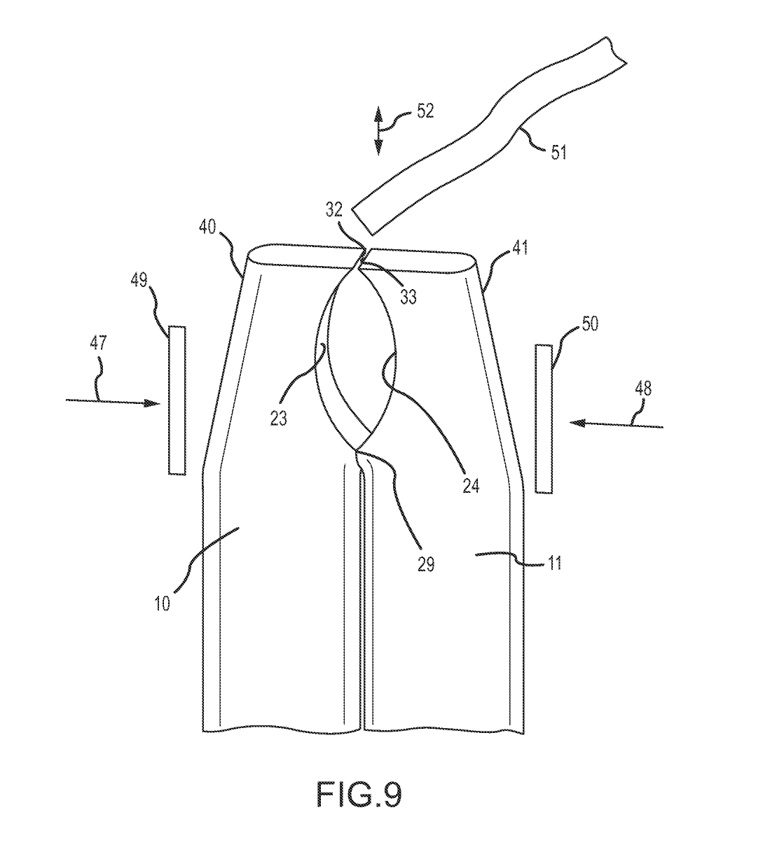

FIG. 9 is a schematic view of conductor ends 10, 11 during a process of being joined together, according to an exemplary embodiment. A radially outer electrode head 49 and a radially inner electrode head 50 are shown at a distance away from respective conductor contact areas 40, 41 for clarity of description. The illustrated view shows edges 32, 33 already bent, to a position where they are in close proximity, by the compressive force of electrode heads 49, 50.

Compressive forces 47, 48 may each be applied at an angle and/or may be moved axially in order to optimize and direct the compression of surfaces 23, 24 toward one another. Such angle may be changed during a welding operation. Electrode heads 49, 50 are moved axially into position and are then used to apply compressive forces 47, 48 in opposed radial directions. A brazing alloy tape 51 may be applied to the intersection of edges 32, 33 after they are bent to be contiguous. As shown by placement direction arrow 52, brazing tape 51 is moved axially into the brazing location and is pulled away from the brazing location in order to break brazing tape 51 away from the target surface when sufficient brazing alloy has been applied. Brazing tape 51 may alternatively be applied at location 29, and the brazing alloy may alternatively be utilized in the form of preformed brazing clips rather than as a tape.

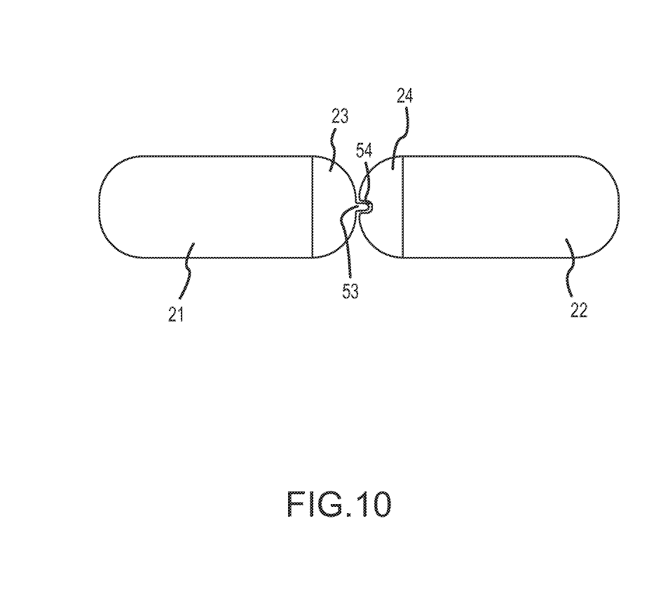

FIG. 10 is a top plan view of two exemplary hairpin conductor ends in position for being connected to one another, according to an exemplary embodiment. Conductor ends 21, 22 are placed into abutment or into close proximity at a location 29 (e.g., FIG. 4) axially inward of the outer axial extremity of conductor ends 21, 22. Tapered surfaces 23, 24 are formed with features for maintaining alignment of conductor ends 21, 22 during the joinder operation. In the illustrated example, a tongue 53 is formed along tapered surface 23 and a groove 54 is formed along tapered surface 24. As conductor ends 21, 22 are compressed together (e.g., FIG. 8 or FIG. 9), tongue 53 mates with groove 54 and thereby aligns conductor ends 21, 22. Features 53, 54 may be formed to be self-aligning. For example, tongue 53 and groove 54 may be formed so that as tongue 53 is inserted into groove 54, the mating is made more precise. Tongue 53 and groove 54 may be formed at any corresponding portions along an axis between location 29 and the axial outer portions of conductor ends 21, 22. Tongue 53 and groove 54 may be formed as projections that extend radially away from the otherwise planar faces of tapered surfaces 23, 24. Tongue 53 and groove 54 may be formed as axial extensions of location 29. Many other alternative mating/alignment features, such as interlocking, grooved, or barrier forms, may be formed along tapered surfaces 23, 24. Similarly, conductor contact surfaces 40, 41 (e.g., FIG. 8) may be formed with features that engage or otherwise cooperate with respective electrode contacting surfaces 43, 45 so that conductor ends 21, 22 do not slip during the joinder operation. Such engagement aligns conductor ends 21, 22 and prevents lateral movement thereof until the weld has cooled in place.

By the disclosed embodiments, it can be seen that the surface area of a welded joint is substantially increased by creating tapered faying surfaces 23, 24. This increased joint surface area provides improved electrical performance of an electric machine, including a larger current path, improved machine efficiency, reduced operational temperatures, and reduced power losses. For example, typical electrical currents through a given conductor end joint of a hairpin conductor may be more than 300 amperes, and any improvement in current capability at hairpin joints results in substantial overall machine performance. In a worst case, a thin hairpin connection may act as a fuse and cause an electric machine to stop operating.

While various embodiments incorporating the present invention have been described in detail, further modifications and adaptations of the invention may occur to those skilled in the art. However, it is to be expressly understood that such modifications and adaptations are within the spirit and scope of the present invention.

What is claimed is:

1. A method of forming a stator winding, comprising:
providing a stator core having a plurality of longitudinally extending slots formed about a circumference thereof;
providing a plurality of hairpin conductors each having a substantially rectangular cross-section and each having an apex portion and a pair of legs that terminate at respective ends;
cutting a bevel at each leg end;
inserting the hairpin legs into respective ones of the slots so that the leg ends extend from an axial end of the stator core;
bending the hairpin legs to form a plurality of adjacent pairs of leg ends with beveled cuts facing one another;
compressing the beveled cuts of each pair together; and
resistance welding the pairs to form a plurality of welded joints.

2. The method of claim 1, wherein each beveled cut provides a plane substantially orthogonal to a cross-sectionally long side of the corresponding hairpin conductor.

3. The method of claim 2, wherein the plane is substantially symmetrical respecting a cross-sectionally short side of the corresponding hairpin conductor.

4. The method of claim 1, wherein the resistance welding comprises a softening period and a welding period, the softening period including at least a portion of the compressing step.

5. The method of claim 1, wherein the compressing includes bending the leg ends of each adjacent pair so that the respective beveled cuts engage one another.

6. The method of claim 5, further comprising forming features into respective ones of the facing beveled cuts, wherein the compressing engages features of each adjacent pair.

7. The method of claim 6, wherein the features include a tongue and groove.

8. The method of claim 1, wherein the resistance welding includes applying a brazing alloy to the compressed pairs.

9. The method of claim 8, wherein the brazing alloy comprises silver, copper, and phosphorous.

10. The method of claim 1, wherein the bending forms an angle between beveled faces of about fifteen to thirty degrees.

11. The method of claim 1, wherein the compressing step includes a pair of electrodes engaging non-beveled, short cross-sectional sides of an adjacent pair being welded and moving toward one another with a force.

12. The method of claim 11, wherein movement of the electrodes toward one another terminates with a final angle between electrodes of about 120 to 160 degrees.

13. The method of claim 11, wherein movement of the electrodes toward one another is stepped from an initial angle between electrodes to a smaller angle between electrodes.

14. The method of claim 11, wherein at least one of the electrodes engages both a top end and a non-beveled, short cross-sectional side of one of the hairpin legs being welded.

15. The method of claim 11, wherein at least one of the electrodes includes a feature for engaging a hairpin leg and restricting circumferential movement thereof.

16. The method of claim 1, wherein the compressing includes modulating a compressing force to maintain welding heat at the compressed beveled cuts.

17. The method of claim 16, wherein the resistance welding includes modulating a welding current based on the modulation of the compressing force.

18. The method of claim 1, wherein the resistance welding includes modulating a welding current based on an amount of softening of the leg ends.

19. The method of claim 1, wherein the resistance welding includes stepping a welding current between at least two different current levels.

20. The method of claim 1, wherein the compressing includes modulating a compressing force based on a modulation of a welding current.
